(19) United States
(12) Patent Application Publication
(10) Pub. No.: US 2026/0018670 A1
(43) Pub. Date: Jan. 15, 2026

(54) SECONDARY BATTERY AND ELECTRONIC DEVICE

(71) Applicant: Ningde Amperex Technology Limited, Ningde (CN)

(72) Inventors: Lilan ZHANG, Ningde (CN); Chao TANG, Ningde (CN); Wenqiang LI, Ningde (CN)

(73) Assignee: Ningde Amperex Technology Limited, Ningde (CN)

(21) Appl. No.: 19/335,021

(22) Filed: Sep. 22, 2025

Related U.S. Application Data
(63) Continuation of application No. PCT/CN2023/083059, filed on Mar. 22, 2023.

(51) Int. Cl. H01M 10/0567; H01M 4/02; H01M 4/38; H01M 10/0569; H01M 10/0585; H01M 10/0587

(52) U.S. Cl. CPC H01M 10/0567; H01M 4/386; H01M 10/0569; H01M 10/0585; H01M 10/0587; H01M 2004/027

(57) ABSTRACT

An electrode assembly includes a positive electrode, a negative electrode, and a separator, and the separator is disposed between the positive electrode and the negative electrode; the electrode assembly satisfies 20≤n*x/y≤2000, where n represents a quantity of layers of the positive electrode along a thickness direction of the electrode assembly, x represents a dimension of the longest edge of a projection of the electrode assembly along the thickness direction, and y represents a maximum dimension of the electrode assembly along the thickness direction; the electrolyte includes a first additive with a reduction potential of 0.8 V to 1.8 V; and a mass percentage of the first additive in the electrolyte is denoted as a, where a is 0.1% to 15%.

### CROSS-REFERENCE TO RELATED APPLICATION

This application is a continuation under 35 U.S.C. § 120 of international patent application PCT/CN2023/083059 filed on Mar. 22, 2023, the entire content of which is incorporated herein by reference.

### TECHNICAL FIELD

This application relates to the field of battery technology, and more specifically, to a secondary battery and an electronic device.

### BACKGROUND

Secondary batteries, particularly lithium-ion batteries, are widely used in products such as digital electronic devices, energy storage apparatuses, drones, electric tools, and electric vehicles due to their high energy density, long cycle life, high safety, and fast charge properties. However, since invention of lithium-ion batteries, safety has consistently been a critical issue limiting their application scenarios.

During the charge process of secondary batteries, lithium or sodium precipitation easily occurs at the negative electrode interface. As a highly reactive metal, lithium or sodium, once precipitated, reacts with the electrolyte, leading to risks of battery swelling or combustion.

Therefore, a secondary battery with good safety performance is needed.

### SUMMARY

This application provides a secondary battery and an electronic device, to mitigate lithium or sodium precipitation at a negative electrode interface, thereby improving the safety performance of the secondary battery.

According to a first aspect, this application provides a secondary battery including: an electrode assembly and an electrolyte, where the electrode assembly includes a positive electrode, a negative electrode, and a separator, and the separator is disposed between the positive electrode and the negative electrode;
the electrode assembly satisfies 20≤n*x/y≤2000, where
n represents a quantity of layers of the positive electrode along a thickness direction of the electrode assembly,
x represents a dimension of the longest edge of a projection of the electrode assembly along the thickness direction, and
y represents a maximum dimension of the electrode assembly along the thickness direction; and
the electrolyte includes a first additive with a reduction potential of 0.8 V to 1.8 V, and a mass percentage of the first additive in the electrolyte is denoted as a, where a is 0.1% to 15%.

According to this application, by optimizing a structural dimension of the electrode assembly and a composition of the electrolyte in the secondary battery, the electrode assembly possesses an appropriate structural dimension. In this case, deformation does not easily occur, and electrolyte infiltration is easy, maintaining structural stability of the battery during charge and discharge. The first additive in the electrolyte can form a solid electrolyte interphase film at a negative electrode interface that facilitates ion transport. Under synergistic effects, an ion conduction rate in the secondary battery can be effectively improved, thereby mitigating lithium or sodium precipitation at the negative electrode interface in the secondary battery and improving the safety performance of the secondary battery.

In some embodiments, the secondary battery satisfies at least one of the following conditions:

$$40 \leq n * x / y \leq 1 \; 500 ; \qquad ( 1 )$$

$$or$$

$$a is 0.5 \% to 10 \% . \qquad ( 2 )$$

In some embodiments, the secondary battery satisfies at least one of the following conditions:

$$300 \leq n * x / y \leq 1 \; 500 ; \qquad ( 3 )$$

$$or$$

$$a is 1 \% to 5 \% . \qquad ( 4 )$$

In some embodiments, the first additive includes at least one of fluoroethylene carbonate, vinylene carbonate, lithium difluoro(oxalato)borate, difluoropyridine, lithium tetrafluoroborate, lithium difluorophosphate, 1,3-dioxane, 1,4-dioxane, or 1,3-dioxolane.

In some embodiments, the secondary battery satisfies at least one of the following conditions:

$$8 \leq n \leq 45 ; \qquad ( 5 )$$

$$1.8 cm \leq x \leq 20 cm ; \qquad ( 6 )$$

$$or$$

$$0.22 cm \leq y \underline{<} 1 cm . \qquad ( 7 )$$

In some embodiments, the secondary battery satisfies at least one of the following conditions:

$$10 \leq n \leq 30 ; \qquad ( 8 )$$

$$3 cm \leq x \leq 12 cm ; \qquad ( 9 )$$

$$0.3 cm \leq y \underline{<} 0.8 cm . \qquad ( 10 )$$

In some embodiments, the electrolyte includes a chain ester compound, a mass percentage of the chain ester compound in the electrolyte is denoted as b, and a ratio b/a of b to a is 1 to 30.

In some above embodiments, a certain amount of the chain ester compound can reduce a viscosity of the electrolyte, improving an ion conduction rate. An electrolyte with a low viscosity can implement better infiltration into the electrode assembly, further enhancing the safety performance of the battery.

In some embodiments, the electrolyte includes a chain ester compound, a mass percentage of the chain ester compound in the electrolyte is denoted as b, and a ratio b/a of b to a is 4 to 25.

In some embodiments, the chain ester compound includes at least one of dimethyl carbonate, diethyl carbonate, ethyl methyl carbonate, methyl acetate, ethyl propionate, propyl propionate, methyl propionate, ethyl fluoroacetate, methyl difluoroacetate, ethyl difluoroacetate, ethyl trifluoroacetate, methyl trifluoroacetate, tert-butyl trifluoroacetate, ethyl 2,2,2-trifluoroacetate, ethyl 2-fluoroisobutyrate, butyl trifluoroacetate, methyl 2-fluoroisobutyrate, methyl 2,2-difluoropropionate, vinyl trifluoroacetate, ethyl 2-fluoropropionate, n-butyl difluoroacetate, bis(2,2,2-trifluoroethyl) carbonate, 2,2,2-trifluoroethyl carbonate, methyl trifluoroethyl carbonate, or ethyl trifluoroethyl carbonate.

In some embodiments, b is 10% to 40%.

In some embodiments, the electrolyte further includes a second additive, and a mass percentage of the second additive is denoted as c, where c is 1% to 10%; and
the second additive is selected from at least one of succinonitrile, glutaronitrile, adiponitrile, pimelonitrile, suberonitrile, azelanitrile, triphenyl phosphate, triethyl trimethylsilyl phosphate, or 1,3,6-hexanetricarbonitrile.

In some of the above embodiments, adding a certain amount of the second additive to the electrolyte enables the second additive to participate in forming a positive electrode solid electrolyte interphase film, effectively suppressing side reactions at the positive electrode interface, thereby enhancing stability of the positive electrode interface. During thermal safety testing, this can extend the time to thermal runaway, further improving the safety performance of the battery.

In some embodiments, the negative electrode includes a negative electrode active material layer, the negative electrode active material layer includes a negative electrode active material, and the negative electrode active material includes a silicon-based active material.

In the above embodiments, using the silicon-based active material can increase an energy density of the battery and mitigate lithium or sodium precipitation, thereby further enhancing the safety performance of the battery.

In some embodiments, a mass percentage of the silicon-based active material in the negative electrode active material is denoted as M, where M is 0.5% to 70%.

According to a second aspect, this application provides an electronic device, including the secondary battery according to any embodiment of the first aspect.

### BRIEF DESCRIPTION OF DRAWINGS

To more clearly illustrate technical solutions of some embodiments of this application, drawings used in these embodiments of this application are briefly introduced below. It is clear that the drawings described below are merely some embodiments of this application, and persons of ordinary skill in the art can obtain other drawings based on these drawings without creative efforts.

FIG. 1 is a schematic diagram of an appearance of a secondary battery according to an embodiment of this application;

FIG. 2 is a projection of an electrode assembly along a thickness direction according to an embodiment of this application;

FIG. 3 is a cross-sectional view of an electrode assembly parallel to a thickness direction according to an embodiment of this application;

FIG. 4 is a schematic structural diagram of a secondary battery according to an embodiment of this application; and

FIG. 5 is a projection of an electrode assembly along a thickness direction according to an embodiment of this application.

Herein, 1: positive electrode; 2. separator; and 3. negative electrode.

### DETAILED DESCRIPTION

To make the objectives, technical solutions, and advantages of some embodiments of this application clearer, the technical solutions in these embodiments of this application are described clearly below with reference to the drawings in these embodiments of this application. It is clear that the described embodiments are some but not all embodiments of this application. Based on these embodiments in this application, all other embodiments obtained by persons of ordinary skill in the art without creative efforts fall within the protection scope of this application.

Unless otherwise defined, all technical and scientific terms used in this application have the same meanings as commonly understood by persons skilled in the technical field of this application. Terms used in this application are for the purpose of describing specific embodiments only and are not intended to limit this application. Terms “including” and “having” in the specification, claims, and drawings of this application, as well as any variations thereof, are intended to cover non-exclusive inclusion. Terms such as “first” and “second” in the specification, claims, or drawings of this application are used to distinguish different objects, not to describe a specific order or primary-secondary relationship.

Reference to an “embodiment” in this application means that a specific feature, structure, or characteristic described with reference to the embodiment may be included in at least one embodiment of this application. The appearance of this phrase in various places in the specification does not necessarily refer to a same embodiment, nor is it an independent or alternative embodiment mutually exclusive with other embodiments.

In the description of this application, it should be noted that, unless otherwise specified and explicitly defined, terms “mount”, “connect”, “join”, and “attach” should be understood in their general senses. For example, they may refer to a fixed connection, a detachable connection, or an integral connection; a direct connection, an indirect connection via an intermediate medium, or internal communication between two elements. Persons of ordinary skill in the art can understand the specific meanings of these terms in this application based on specific circumstances.

The term “and/or” in this application merely describes an association relationship between associated objects, indicating that three relationships may exist. For example, A and/or B may represent: A alone, both A and B, or B alone. Additionally, the character “/” in this application generally indicates an “or” relationship between the contextually associated objects.

In these embodiments of this application, a same reference sign denotes a same component. For brevity, detailed descriptions of the same components are not repeated in different embodiments. It should be understood that dimensions such as thickness, length, and width of various components in these embodiments of this application shown in the drawings, as well as overall thickness, length, and width of an integrated apparatus, are for illustrative purposes only and should not constitute any limitation to this application.

The term “plurality” appearing in this application refers to two or more (including two).

The reduction potential appearing in this application refers to a potential relative to Li⁺/Li.

As described in the background, in currently widely used secondary batteries, lithium or sodium precipitation at a negative electrode interface during charge easily reacts with an electrolyte, posing safety risks.

In view of this, the inventors, through analysis, have found that lithium or sodium precipitation at the negative electrode interface during charge is primarily triggered by a slow ion conduction rate in a battery. When the negative electrode is unable to rapidly and fully intercalate ions, lithium or sodium precipitation is triggered. Especially during low-temperature charge, an impedance for ion intercalation at the negative electrode is significantly higher than an impedance for ion deintercalation at the positive electrode. Although ions can deintercalate relatively quickly from the positive electrode at a low temperature, the ions cannot be timely intercalated into the negative electrode, leading to lithium or sodium precipitation, side reactions with the electrolyte, and subsequent thermal runaway, posing safety risks.

Based on the above reasons, the inventors have provided a secondary battery and an electronic device. A structural dimension of an electrode assembly and a composition of an electrolyte in the secondary battery are optimized, improving an ion conduction rate of the battery, thereby effectively mitigating lithium or sodium precipitation and improving the safety performance of the battery. The secondary battery and electronic device provided by this application are described in detail below.

### Secondary Battery

In the following description, a lithium-ion battery is used as an example of a secondary battery for illustration. It should be understood that the secondary battery includes, but is not limited to, a lithium-ion battery.

According to a first aspect, this application provides a secondary battery, including an electrode assembly and an electrolyte, where the electrode assembly includes a positive electrode, a negative electrode, and a separator, and the separator is disposed between the positive electrode and the negative electrode;
the electrode assembly satisfies 20≤n*x/y≤2000, where
n represents a quantity of layers of the positive electrode along a thickness direction of the electrode assembly,
x represents a dimension of the longest edge of a projection of the electrode assembly along the thickness direction, and
y represents a maximum dimension of the electrode assembly along the thickness direction; and
the electrolyte includes a first additive with a reduction potential of 0.8 V to 1.8 V, and a mass percentage of the first additive in the electrolyte is denoted as a, where a is 0.1% to 15%.

According to this application, a structural dimension of the electrode assembly and a composition of the electrolyte in the secondary battery are optimized. The structure of the electrode assembly is similar to that of existing electrode assemblies, with the primary difference being the optimized structural dimension of the electrode assembly. Herein, n represents a quantity of layers of the positive electrode along the thickness direction of the electrode assembly; y represents a maximum dimension of the electrode assembly along the thickness direction, that is, a value of y/n is positively correlated with the thicknesses of the positive electrode and negative electrode; and x represents a dimension of the longest edge of a projection of the electrode assembly along the thickness direction. Thus, with a smaller y/n value and a larger x value, the electrode assembly is more prone to deformation.

When a value of n*x/y is excessively large, the electrode assembly is prone to deformation during charge and discharge or under external forces. Deformation may lead to poor contact at the positive/negative electrode interface at a deformed area of the electrode assembly, reducing an ion transport rate, thereby causing lithium ion precipitation at the negative electrode interface and deteriorating the safety performance of the battery. When a value of n*x/y is excessively small, although the electrode assembly is less prone to deformation, an increased thickness makes the electrolyte infiltration into the electrode assembly difficult, which is also detrimental to ion transport, leading to lithium precipitation at the negative electrode interface and deteriorating the safety performance of the battery.

Additionally, the electrolyte in the secondary battery of this application includes a first additive with a reduction potential (vs Li⁺/Li) of 0.8 V to 1.8 V. Due to a relatively high reduction potential, the first additive can form a solid electrolyte interphase (SEI) film at the negative electrode interface prior to a solvent in the electrolyte, preventing adverse effects of the solvent on the negative electrode interface. The resulting SEI film has diverse grain boundaries, effectively enhancing ion transport of the SEI film, increasing an ion conduction rate, and suppressing abnormal lithium precipitation at the negative electrode interface. This application further specifies that a mass percentage of the first additive in the electrolyte in the electrolyte is 0.1% to 15%, for example, 0.1%, 0.2%, 0.4%, 0.6%, 0.8%, 1%, 2%, 3%, 4%, 5%, 6%, 7%, 8%, 9%, 10%, 11%, 12%, 13%, 14%, 15%, or may be within a range defined by any of the above values. If the percentage is excessively low, a stable and effective SEI film cannot be formed, and therefore cannot prevent further reactions of the solvent in the electrolyte at the negative electrode interface. In this case, adverse effects of the solvent on the negative electrode interface cannot be prevented. If the percentage is excessively high, the formed SEI film may be excessively thick, affecting the ion conduction rate.

In the secondary battery of this application, based on the use of the above electrolyte, extensive experiments have suggested that when n*x/y of the electrode assembly is set to a range of 20 to 4000, for example, n*x/y may be 20, 40, 60, 80, 100, 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, or within a range defined by any of the above values, the electrode assembly has an appropriate structural dimension and is not prone to deformation, and electrolyte infiltration is easy. In this case, the ion conduction rate is high, lithium ion precipitation at the negative electrode interface is mitigated, and structural stability of the battery is maintained during charge and discharge. In this case, the safety performance of the battery is improved.

Thus, in the secondary battery provided by this application, the electrode assembly with an optimized structural dimension and the electrolyte containing a specific amount of the first additive synergistically mitigate lithium precipitation at the negative electrode interface, improving the safety performance of the battery.

It should be noted that persons skilled in the art can understand that the electrolyte includes a solvent and a lithium salt, and types and mass percentages thereof can be selected as needed. For example, the solvent may include, but is not limited to, at least one of a cyclic ester solvent, chain ester solvent, an ether solvent, or a benzene solvent; the lithium salt may include, but is not limited to, at least one of LiPF₆ (lithium hexafluorophosphate), LiBF₄ (lithium tetrafluoroborate), LiClO₄ (lithium perchlorate), LiFSI (lithium bis(fluorosulfonyl)imide), LiTFSI (lithium bis(trifluoromethanesulfonyl)imide), LiTFS (lithium trifluoromethanesulfonate), LiDFOB (lithium difluoro(oxalato)borate), LiBOB (lithium bis(oxalato)borate), LiPO₂F₂ (lithium difluorophosphate), LiDFOP (lithium difluorodioxalatophosphate), or LiTFOP (lithium tetrafluorooxalatophosphate).

In some embodiments, the secondary battery satisfies at least one of the following conditions:

$$40 \leq n * x / y \leq 1 \; 500 ; \qquad ( 1 )$$

$$or$$

$$a is 0.5 \% to 10 \% . \qquad ( 2 )$$

In the above embodiments, the structural dimension of the electrode assembly and the mass percentage of the first additive in the secondary battery are further optimized, and the secondary battery satisfying any of the above conditions exhibits improved safety performance.

In some embodiments, the secondary battery satisfies at least one of the following conditions:

$$300 \leq n * x / y \leq 1 \; 500 ; \qquad ( 3 )$$

$$or$$

$$a is 1 \% to 5 \% . \qquad ( 4 )$$

In the above embodiments, extensive experiments have suggested that when the structural dimension of the electrode assembly and the mass percentage of the first additive in the secondary battery satisfy any of the above conditions, the secondary battery exhibits improved safety performance.

In some embodiments, the first additive includes at least one of fluoroethylene carbonate, vinylene carbonate, lithium difluoro(oxalato)borate, difluoropyridine, lithium tetrafluoroborate, lithium difluorophosphate, 1,3-dioxane, 1,4-dioxane, or 1,3-dioxolane.

In the above embodiments, a specific type of the first additive is further specified. In addition to the advantages of the first additive described above, the foregoing additive can effectively reduce coordination between the solvent and lithium ions in the electrolyte, thereby lowering desolvation energy of lithium ions in the electrolyte, enabling rapid desolvation of lithium ions at the negative electrode interface, thus increasing the lithium ion conduction rate and reducing lithium precipitation at the negative electrode interface. Persons skilled in the art can select at least one of the above compounds as the first additive based on actual needs. It should be understood that the first additive is not limited to the above compounds, and the first additive may also include compounds in the prior art that can achieve the above effects.

In some embodiments, the secondary battery satisfies at least one of the following conditions:

$$8 \leq n \leq 45 ; \qquad ( 5 )$$

$$1.8 cm \leq x \leq 20 cm ; \qquad ( 6 )$$

$$or$$

$$0.22 cm \leq y \underline{<} 1 cm . \qquad ( 7 )$$

In some of the above embodiments, specific ranges for n, x, and y are further specified. The parameter n may be 8 to 45, for example, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, or may be within a range defined by any of the above values. If n is excessively small, the electrode assembly is not easily infiltrated by the electrolyte, easily leading to lithium precipitation at the negative electrode interface. If n is excessively large, the electrode assembly is more prone to deformation, deteriorating safety performance. Additionally, when y is fixed, a larger n results in more layers of the separator, reducing an energy density of the battery.

The parameter x may be 1.8 cm to 20 cm, for example, 2 cm, 3 cm, 4 cm, 5 cm, 6 cm, 7 cm, 8 cm, 9 cm, 10 cm, 11 cm, 12 cm, 13 cm, 14 cm, 15 cm, 16 cm, 17 cm, 18 cm, 19 cm, 20 cm, or may be within a range defined by any of the above values. If x is excessively small, it is not conducive to obtaining a battery with a large capacity. If x is excessively large, the electrode assembly is prone to deformation, leading to lithium precipitation at the negative electrode interface in the deformed area.

The parameter y may be 0.22 cm to 1 cm, for example, 0.22 cm, 0.24 cm, 0.26 cm, 0.28 cm, 0.3 cm, 0.35 cm, 0.4 cm, 0.45 cm, 0.5 cm, 0.55 cm, 0.6 cm, 0.65 cm, 0.7 cm, 0.75 cm, 0.8 cm, 0.85 cm, 0.9 cm, 1 cm, or may be within a range defined by any of the above values. If y is excessively small, the electrode assembly is prone to deformation, deteriorating safety performance. If y is excessively large, the electrode assembly is not easily infiltrated by the electrolyte, which may also lead to lithium precipitation at the negative electrode interface, deteriorating safety performance.

In some embodiments, the secondary battery satisfies at least one of the following conditions:

$$10 \leq n \leq 30 ; \qquad ( 8 )$$

$$3 cm \leq x \leq 12 cm ; \qquad ( 9 )$$

$$or$$

$$0.3 cm \leq y \underline{<} 0.8 cm . \qquad ( 10 )$$

In some of the above embodiments, the parameters n, x, and y of the electrode assembly in the secondary battery are further optimized. When n, x, and y satisfy any of the above conditions, the secondary battery exhibits improved safety performance.

In some embodiments, the electrolyte includes a chain ester compound, a mass percentage of the chain ester compound in the electrolyte is denoted as b, and a ratio b/a of b to a is 1 to 30.

In some of the above embodiments, it is specifically specified that the electrolyte includes a chain ester compound and a mass percentage thereof is specified. The chain ester compound serves as a solvent in the electrolyte, and can dissociate a lithium salt to some degree. However, a dielectric constant is relatively low, resulting in a low degree of dissociation of the lithium salt. In this case, lithium ions easily desolvate at the negative electrode interface. Additionally, the chain ester compound can reduce a viscosity of the electrolyte and then improve the ion conduction rate of lithium ions, and the electrolyte with low viscosity exhibits better infiltration to the electrode assembly, thereby allowing an appropriate increase in the value of y/n of the electrode assembly, further enhancing the safety performance of the battery.

Moreover, since the chain ester compound has an adverse effect on the negative electrode interface, and is prone to decomposition at the negative electrode interface, the first additive in the electrolyte can preferentially form an SEI film at the negative electrode interface prior to the chain ester compound, protecting the negative electrode interface and suppressing adverse effects of the chain ester compound on the negative electrode interface. Therefore, a mass ratio b/a of the chain ester compound to the first additive in the electrolyte should fall within a range of 1 to 30, for example, b/a may be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, or within a range defined by any of the above values. If b/a is excessively small, an excessive amount of the first additive may lead to an excessively high impedance at the negative electrode interface, affecting lithium ion transport. If b/a is excessively large, excessive decomposition of the chain ester compound at the negative electrode interface leads to deterioration of the safety performance of the battery.

In some embodiments, the electrolyte includes a chain ester compound, a mass percentage of the chain ester compound in the electrolyte is denoted as b, and a ratio b/a of b to a is 4 to 25.

In some of the above embodiments, in extensive experiments, the condition of b/a is further optimized. When b/a is 4 to 25, the secondary battery exhibits improved safety performance.

In some embodiments, the chain ester compound includes at least one of dimethyl carbonate, diethyl carbonate, ethyl methyl carbonate, methyl acetate, ethyl propionate, propyl propionate, methyl propionate, ethyl fluoroacetate, methyl difluoroacetate, ethyl difluoroacetate, ethyl trifluoroacetate, methyl trifluoroacetate, tert-butyl trifluoroacetate, ethyl 2,2,2-trifluoroacetate, ethyl 2-fluoroisobutyrate, butyl trifluoroacetate, methyl 2-fluoroisobutyrate, methyl 2,2-difluoropropionate, vinyl trifluoroacetate, ethyl 2-fluoropropionate, n-butyl difluoroacetate, bis(2,2,2-trifluoroethyl) carbonate, 2,2,2-trifluoroethyl carbonate, methyl trifluoroethyl carbonate, or ethyl trifluoroethyl carbonate.

In some of the above embodiments, commonly used chain ester compounds in the field are specifically listed. Persons skilled in the art can select at least one of the above compounds as needed. It should be understood that the above compounds are merely examples and not limited to the listed compounds. The chain ester compound may also include other chain ester compounds applicable to electrolytes in the prior art.

In some embodiments, b is 10% to 40%.

In some of the above embodiments, a mass percentage of the chain ester compound in the electrolyte is specifically specified as b ranging from 10% to 40%, for example, b may be 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, or within a range defined by any of the above values. If b is excessively small, the viscosity of the electrolyte cannot be effectively reduced, and lithium ions are less prone to desolvation at the negative electrode interface, leading to lithium precipitation at the negative electrode interface. If b is excessively large, due to the low dielectric constant, it is not conducive to dissociation of the lithium salt, reducing a concentration of transportable lithium ions, which in turn reduces the ion conduction rate, leading to lithium precipitation at the negative electrode interface and deteriorating the safety performance of the battery.

It should be understood that, to ensure a dissociation degree of the lithium salt in the electrolyte, the electrolyte includes a cyclic ester compound. The cyclic ester compound has a high dielectric constant, ensuring sufficient lithium ions in the electrolyte. The cyclic ester compound may include, but is not limited to, at least one of propylene carbonate, ethylene carbonate, or γ-butyrolactone. A specific type and a mass percentage of the cyclic ester compound can be selected by persons skilled in the art based on actual needs.

In some embodiments, the electrolyte further includes a second additive, and a mass percentage of the second additive is denoted as c, where c is 1% to 10%.

In some of the above embodiments, the electrolyte may further include a second additive, which participates in forming a solid electrolyte interphase film at the positive electrode, effectively suppressing side reactions at the positive electrode interface, thereby enhancing stability of the positive electrode interface. During thermal safety test, thermal runaway can be delayed, improving the safety performance of the battery.

A mass percentage of the second additive is further specified as c, ranging from 1% to 10%, for example, c may be 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, or within a range defined by any of the above values. If c is excessively small, the above effects cannot be achieved at the positive electrode interface. If c is excessively large, the safety performance of the battery cannot be improved, and the conduction rate of lithium ions at the negative electrode interface is reduced. This is not conducive to improving the safety performance of the battery.

In some embodiments, the second additive is selected from at least one of succinonitrile, glutaronitrile, adiponitrile, pimelonitrile, suberonitrile, azelanitrile, triphenyl phosphate, triethyl trimethylsilyl phosphate, or 1,3,6-hexanetricarbonitrile.

In some of the above embodiments, some compounds are specifically listed. Persons skilled in the art can select at least one of the above compounds as needed. It should be understood that the second additive is not limited to the above compounds, and persons skilled in the art can select compounds in the prior art that can achieve the above effects based as needed.

### Negative Electrode

In some embodiments, the negative electrode includes a negative electrode active material layer, the negative electrode active material layer includes a negative electrode active material, and the negative electrode active material includes a silicon-based active material.

In some of the above embodiments, by optimizing the structural dimension of the electrode assembly and a composition of the electrolyte in this application, deformation of the battery due to swelling during cycling can be alleviated, effectively maintaining overall structural stability during charge and discharge. The optimized electrolyte can effectively improve the conduction rate of lithium ions at the negative electrode interface. Therefore, a silicon-based active material with a higher energy density can be used. Although a volume change rate of the silicon-based active material is high during charge and discharge, the battery provided by this application can ensure safety performance when using the silicon-based active material, thereby effectively increasing an energy density of the battery. Additionally, using the silicon-based active material can mitigate lithium precipitation, further enhancing the safety performance of the battery.

In some embodiments, the silicon-based active material may include, but is not limited to, SiOv (0<v≤2) and/or a silicate, where the silicate includes, but is not limited to, at least one of Li₂SiO₃, Li₂Si₂O₅, or Li₄SiO₄. It should be understood that elemental silicon has a larger volume change rate compared with a silicon oxide or silicate, resulting in poorer safety performance. Therefore, SiOv (0<v<2) and/or silicate with relatively lower volume change rates are used. It should be understood that persons skilled in the art can select other compounds in the prior art that can serve as silicon-based active materials based on actual needs.

In some embodiments, a mass percentage of the silicon-based active material in the negative electrode active material is denoted as M, where M is 0.5% to 70%.

In the above embodiments, a mass percentage of the silicon-based active material in the negative electrode active material is specifically specified as M ranging from 0.5% to 70%, for example, M may be 0.5%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, or within a range formed by any of the above values. If M is excessively low, the energy density of the battery cannot be effectively increased. If M is excessively high, a volume change rate of the negative electrode during charge and discharge is excessively high, deteriorating the safety performance of the battery.

In some embodiments, the negative electrode active material includes, but is not limited to, at least one of natural graphite, artificial graphite, mesocarbon microbeads (MCMB), hard carbon, soft carbon, Li—Sn alloy, Li—Sn—O alloy, Sn, SnO, SnO₂, spinel-structured Li₄Ti₅O₁₂, or Li—Al alloy.

In some embodiments, the negative electrode active material layer may optionally further include a binder. The binder may be selected from at least one of styrene-butadiene rubber (SBR), polyacrylic acid (PAA), sodium polyacrylate (PAAS), polyacrylamide (PAM), polyvinyl alcohol (PVA), sodium alginate (SA), polymethacrylic acid (PMAA), or carboxymethyl chitosan (CMCS).

In some embodiments, the negative electrode active material layer may optionally further include a conductive agent. The conductive agent may be selected from at least one of superconducting carbon, acetylene black, carbon black, Ketjen black, carbon dots, carbon nanotubes, graphene, or carbon nanofibers.

In some embodiments, the negative electrode active material layer may optionally further include another additive, such as a thickener (for example, sodium carboxymethyl cellulose (CMC-Na)).

However, this application is not limited to the above materials. The negative electrode of this application may alternatively use other known materials that can serve as a negative electrode active material, conductive agent, binder, and thickener.

In some embodiments, the negative electrode includes a negative electrode current collector, the negative electrode current collector has two opposite surfaces in a thickness direction of the negative electrode current collector, and the negative electrode active material layer is disposed on either one or both of the two opposite surfaces of the negative electrode current collector.

The negative electrode current collector may use a metal foil or a porous metal plate, for example, a foil or porous plate made of metals such as copper, nickel, titanium, iron, or their alloys. As an example, the negative electrode current collector is a copper foil.

In this application, the negative electrode may be prepared according to conventional methods in the field. For example, the negative electrode active material, the conductive agent, a binder, and the thickener described in the first aspect of this application are dispersed in a solvent to form a uniform negative electrode slurry, where the solvent may be N-methylpyrrolidone (NMP) or deionized water. The negative electrode slurry is applied on the negative electrode current collector, dried, and cold-pressed to obtain the negative electrode active material layer, thereby obtaining the negative electrode.

The negative electrode in this application does not exclude additional functional layers beyond the negative electrode active material layer. For example, in some embodiments, the negative electrode of this application further includes a conductive undercoating layer (for example, formed by a conductive agent and a binder) sandwiched between the negative electrode current collector and the negative electrode active material layer and disposed on a surface of the negative electrode current collector.

### Positive Electrode

Materials, compositions, and manufacturing methods of the positive electrode used in the secondary battery of this application may include any known technologies in the prior art.

The positive electrode includes a positive electrode current collector and a positive electrode active material layer that is disposed on at least one surface of the positive electrode current collector and that includes a positive electrode active material. As an example, the positive electrode current collector has two opposite surfaces in a thickness direction of the positive electrode current collector, and the positive electrode active material layer is disposed on either or both of the two opposite surfaces of the positive electrode current collector.

In some embodiments, the positive electrode active material layer includes a positive electrode active material. A specific type of the positive electrode active material is not particularly limited and can be selected based on needs. For example, the positive electrode active material may include one or more of a lithium transition metal oxide, a lithium-containing phosphate with an olivine structure, or their respective modified compounds. In the secondary battery of this application, the modified compounds of the aforementioned positive electrode active material may be those that have undergone doping modification, surface coating modification, or both doping and surface coating modification of the positive electrode active material.

As an example, the lithium transition metal oxide may include one or more of lithium cobalt oxide, lithium nickel oxide, lithium manganese oxide, lithium nickel cobalt oxide, lithium manganese cobalt oxide, lithium nickel manganese oxide, lithium nickel cobalt manganese oxide, lithium nickel cobalt aluminum oxide, or their modified compounds. As an example, the lithium-containing phosphate with an olivine structure may include one or more of lithium iron phosphate, a composite material of lithium iron phosphate and carbon, lithium manganese phosphate, a composite material of lithium manganese phosphate and carbon, lithium manganese iron phosphate, a composite material of lithium manganese iron phosphate and carbon, or their modified compounds. These positive electrode active materials may be used alone or in combination of two or more.

In some embodiments, the positive electrode active material layer may optionally further include a conductive agent. As an example, the conductive agent may include at least one of superconducting carbon, acetylene black, carbon black, Ketjen black, carbon dots, carbon nanotubes, graphene, or carbon nanofibers.

In some embodiments, the positive electrode active material layer may optionally further include a binder. As an example, the binder may include at least one of polyvinylidene fluoride (PVDF), polytetrafluoroethylene (PTFE), vinylidene fluoride-tetrafluoroethylene-propylene terpolymer, vinylidene fluoride-hexafluoropropylene-tetrafluoroethylene terpolymer, tetrafluoroethylene-hexafluoropropylene copolymer, or fluorine-containing acrylate resin.

In some embodiments, the positive electrode current collector may use a metal foil or a composite current collector. As an example of the metal foil, an aluminum foil may be used as the positive electrode current collector. The composite current collector may include a polymer material base layer and a metal material layer formed on at least one surface of the polymer material base layer. In an example, the metal material may be selected from one or more of aluminum, aluminum alloy, nickel, nickel alloy, titanium, titanium alloy, silver, or silver alloy. As an example, the polymer material base layer may be selected from polypropylene, polyethylene terephthalate, polybutylene terephthalate, polystyrene, polyethylene, or the like.

In this application, the positive electrode may be prepared according to conventional methods in the field. For example, the positive electrode active material layer is typically formed by applying a positive electrode slurry on a positive electrode current collector, followed by drying and cold pressing. The positive electrode slurry is typically formed by dispersing a positive electrode active material, an optional conductive agent, an optional binder, and any other components in a solvent and stirring uniformly. The solvent may be N-methylpyrrolidone (NMP), but is not limited thereto.

The positive electrode in this application does not exclude additional functional layers beyond the positive electrode active material layer. For example, in some embodiments, the positive electrode of this application further includes a conductive undercoating layer (for example, formed with a conductive agent and a binder) disposed on a surface of the positive electrode current collector and sandwiched between the positive electrode current collector and the positive electrode active material layer. In other embodiments, the positive electrode of this application further includes a protective layer covering a surface of the positive electrode active material layer.

### Separator

The separator is disposed between the positive electrode and the negative electrode, primarily serving to prevent short-circuiting between the positive electrode and negative electrode while allowing active ions to pass through. A type of separator is not particularly limited in this application, and any known porous-structured separator with good chemical and mechanical stability may be used.

In some embodiments, a material of the separator may be selected from one or more of glass fiber, non-woven fabric, polyethylene, polypropylene, or polyvinylidene fluoride, but is not limited thereto. Optionally, the material of the separator may include polyethylene and/or polypropylene. The separator may be a single-layer film or a multi-layer composite film. When the separator is a multi-layer composite film, each layer is made of the same or different materials. In some embodiments, the separator may further include a ceramic coating or a metal oxide coating.

In some embodiments, the secondary battery includes an outer packaging for encapsulating the electrode assembly and the electrolyte. In some embodiments, the outer packaging may be a hard shell, such as a hard plastic shell, an aluminum shell, or a steel shell, or may be a soft pack, such as a soft pouch. A material of the soft pouch may be plastic, such as at least one of polypropylene (PP), polybutylene terephthalate (PBT), or polybutylene succinate (PBS).

In some embodiments, the secondary battery is a lithium-ion battery.

### Preparation Method of Secondary Battery

In this application, a preparation method of the secondary battery may include: stacking a positive electrode, a separator, and a negative electrode in sequence, with the separator disposed between the positive electrode and negative electrode to provide isolation, followed by a winding process or a lamination process to form an electrode assembly according to any embodiment of the first aspect.

In some embodiments, the preparation method includes: welding tabs to the electrode assembly, placing the electrode assembly in an outer packaging film, injecting an electrolyte into the electrode assembly, and performing vacuum encapsulation, standing, formation, and shaping processes to obtain a secondary battery.

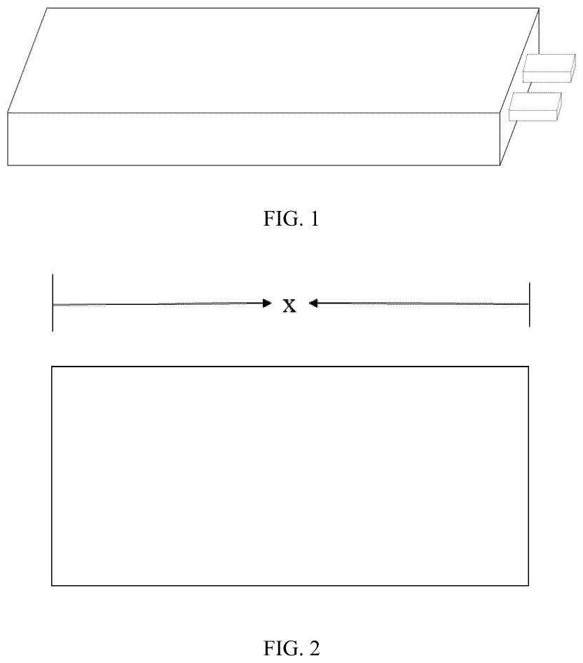

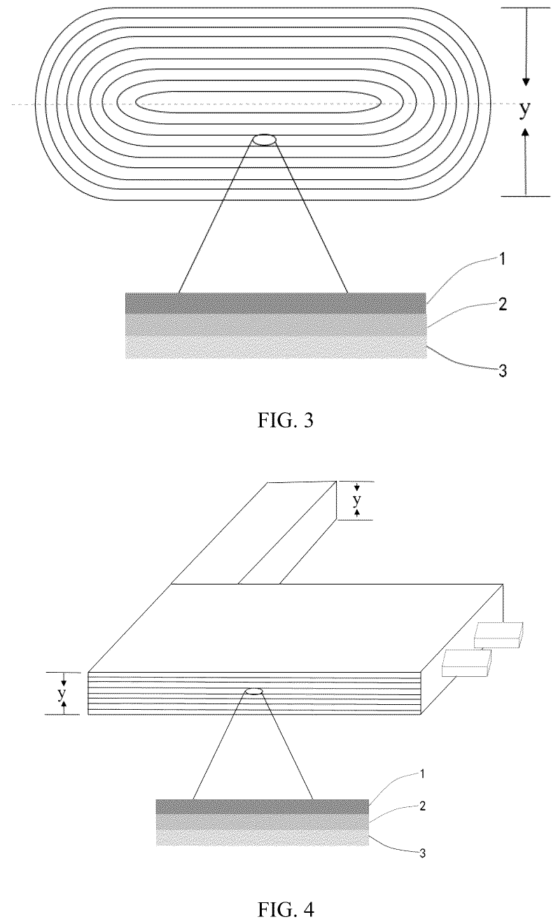

As an example, a positive electrode, a separator, and a negative electrode are stacked in sequence, with the separator disposed between the positive electrode and negative electrode to provide isolation, followed by a winding process to form an electrode assembly. After welding tabs, the electrode assembly is placed in an outer packaging film, the electrolyte is injected into the electrode assembly, and vacuum encapsulation, standing, formation, and shaping processes are performed to obtain a secondary battery. A schematic appearance of the prepared secondary battery is shown in FIG. 1. A projection of the electrode assembly along a thickness direction is shown in FIG. 2, where x is a dimension of the longest edge of the projection. A cross-sectional view of the electrode assembly parallel to the thickness direction is shown in FIG. 3, where y is a maximum dimension of the electrode assembly along the thickness direction. It should be noted that when the electrode assembly is prepared through winding, the positive electrode is considered to form two layers for each complete winding turn. The separator is disposed between the positive electrode 1 and the negative electrode 3 in the electrode assembly for isolation, allowing calculation of a quantity of layers n of the positive electrode along the thickness direction.

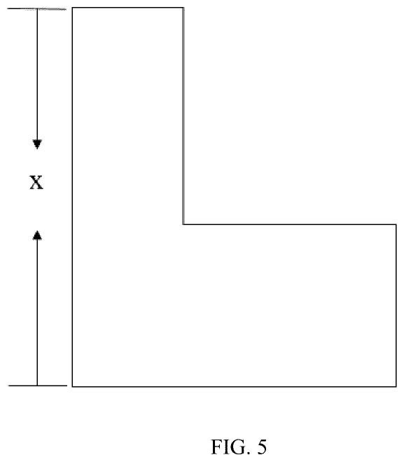

As an example, a positive electrode, a separator, and a negative electrode are stacked in sequence, with the separator disposed between the positive electrode and negative electrode to provide isolation, followed by a lamination process to form an electrode assembly. After welding tabs, the electrode assembly is placed in an outer packaging film, an electrolyte is injected into the electrode assembly, and vacuum encapsulation, standing, formation, and shaping processes are performed to obtain a special-shaped secondary battery. FIG. 4 is a schematic diagram of the special-shaped secondary battery, where y is a maximum dimension of the electrode assembly along the thickness direction. It should be noted that y does not include a thickness of the packaging film, and n is the quantity of layers of the positive electrode along the thickness direction. A projection of the electrode assembly along the thickness direction is shown in FIG. 5, where x is a dimension of the longest edge of the projection.

The above two secondary batteries are examples and do not limit the scope of this application.

According to a second aspect, this application provides an electronic device, including the secondary battery according to any embodiment of the first aspect.

According to this application, since the electronic device includes the secondary battery according to any embodiment of the first aspect, the electronic device has the beneficial effects of the first aspect.

The electronic device of this application is not particularly limited and may be any electronic device known in the prior art. In some embodiments, the electronic device may include, but is not limited to, a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notepad, a calculator, a memory card, a portable recorder, a radio, a standby power source, a motor, an automobile, a motorcycle, a motor bicycle, a bicycle, a lighting appliance, a toy, a game console, a timepiece, an electric tool, a flash lamp, a camera, a large household battery, or a lithium-ion capacitor.

The following describes examples of this application. The examples described below are illustrative and used only to explain this application, and should not be construed as limitations on this application. For examples where specific techniques or conditions are not specified, they are performed according to techniques or conditions described in the literature in the field or according to product specifications. Reagents or instruments used are all conventional products commercially available if no manufacturer is indicated.

Lithium precipitation test: At −10° C., a battery was charged at a constant current of 0.5 C to 4.45 V, and charged at a constant voltage to 0.025 C; discharged at a constant voltage of 0.5 C to 3.0 V, and left standing for 5 minutes; and charged and discharged 10 times, and fully charged to 4.45 V. The fully charged cell was disassembled to observe a degree of lithium precipitation at a negative electrode interface. Battery lithium precipitation was classified into 8 levels from level 1 to level 8 based on an area of lithium precipitation at the negative electrode interface, where 1 represents the least lithium precipitation and 8 represents the most severe lithium precipitation.

Safety test: A battery cycled 100 times at 0° C. was placed in a high-temperature furnace at 130° C. A time at which thermal runaway occurred on the cell was recorded. A shorter thermal runaway time indicates poorer battery safety.

### EXAMPLE 1-1

### Preparation of Positive Electrode

97% lithium cobalt oxide, 1% conductive carbon black, and 2% polyvinylidene fluoride were mixed in NMP to obtain a positive electrode active slurry with a solid content of 75 wt %. The positive electrode active slurry was applied to an aluminum foil. The aluminum foil was dried at 95° C., and after cold pressing, cutting, and slitting, dried at 85° C. under vacuum for 4 h to obtain a positive electrode.

### Preparation of Negative Electrode

96.4% negative electrode active material, 1.5% conductive agent Super P, 0.5% thickener sodium carboxymethyl cellulose (CMC), and 1.6% binder styrene-butadiene rubber (SBR) were mixed in deionized water to obtain a negative electrode active slurry, where the negative electrode active material was graphite. The negative electrode active slurry had a solid content of 54 wt %. The negative electrode active slurry was applied to a copper foil. The copper foil was dried at 85° C., and after cold pressing, cutting, and slitting, dried at 80° C. under vacuum for 12 h to obtain the negative electrode.

### Preparation of Electrolyte

A first additive, a chain ester compound, a cyclic ester compound, and LiPF₆ were mixed to obtain an electrolyte, where a type and an amount of the first additive were shown in Table 1. The chain ester compound was diethyl carbonate with a mass percentage of 45%, the cyclic ester compound was ethylene carbonate with a mass percentage of 42%, and a mass percentage of LiPF₆ was 12.5%.

### Preparation of Lithium-Ion Battery

A positive electrode, a separator, and a negative electrode were stacked in sequence, with the separator disposed between the positive electrode and negative electrode to provide isolation, and were wound to obtain an electrode assembly, where n, x, and y of the electrode assembly were shown in Table 1. After welding tabs, a bare cell was placed in an outer packaging foil aluminum-plastic film, the prepared electrolyte was injected into the dried bare cell, and vacuum encapsulation, standing, formation, shaping, and capacity testing processes were performed to obtain a lithium-ion battery.

The safety performance of the obtained lithium-ion battery was tested, and the results were shown in Table 1.

### EXAMPLES 1-2 TO 1-18 AND COMPARATIVE EXAMPLES 1 to 5

Preparation of the positive electrode, negative electrode, separator, electrolyte, and lithium-ion battery was similar to that in Example 1-1. Differences were as follows: n, x, and y of the electrode assembly were different, and a type and an amount a of the first additive were different. Specific parameters were shown in Table 1.

The safety performance of the obtained lithium-ion batteries was tested, and the results were shown in Table 1.

TABLE 1

| | | | | | | | | Thermal |
|---|---|---|---|---|---|---|---|---|
| | | | | | | | Lithium | runaway |
| | n | x | y | | | a | precipitation | time |
| | (layers) | (cm) | (cm) | n*x/y | First additive | (%) | level | (min) |
| Comparative | 10 | 2 | 1 | 20 | / | / | 8 | 34 |
| example 1 | | | | | | | | |
| Comparative | 10 | 2 | 1.1 | 18 | Fluoroethylene | 0.5 | 8 | 35 |
| example 2 | | | | | carbonate | | | |
| Example | 10 | 2 | 1 | 20 | Fluoroethylene | 0.5 | 7 | 42 |
| 1-1 | | | | | carbonate | | | |
| Example | 10 | 2 | 0.5 | 40 | Fluoroethylene | 0.5 | 5 | 43 |
| 1-2 | | | | | carbonate | | | |
| Example | 20 | 8 | 0.5 | 320 | Fluoroethylene | 0.5 | 4 | 45 |
| 1-3 | | | | | carbonate | | | |
| Example | 20 | 8 | 0.4 | 533 | Fluoroethylene | 0.5 | 4 | 46 |
| 1-4 | | | | | carbonate | | | |
| Example | 20 | 12 | 0.3 | 800 | Fluoroethylene | 0.5 | 5 | 48 |
| 1-5 | | | | | carbonate | | | |
| Example | 30 | 15 | 0.3 | 1500 | Fluoroethylene | 0.5 | 7 | 47 |
| 1-6 | | | | | carbonate | | | |
| Example | 40 | 15 | 0.3 | 2000 | Fluoroethylene | 0.5 | 7 | 43 |
| 1-7 | | | | | carbonate | | | |
| Comparative | 40 | 15 | 0.28 | 2142 | Fluoroethylene | 0.5 | 8 | 38 |
| example 3 | | | | | carbonate | | | |
| Comparative | 20 | 12 | 0.3 | 800 | Fluoroethylene | 0.05 | 7 | 38 |
| example 4 | | | | | carbonate | | | |
| Example | 20 | 12 | 0.3 | 800 | Fluoroethylene | 0.1 | 6 | 42 |
| 1-8 | | | | | carbonate | | | |
| Example | 20 | 12 | 0.3 | 800 | Fluoroethylene | 1 | 5 | 49 |
| 1-9 | | | | | carbonate | | | |
| Example | 20 | 12 | 0.3 | 800 | Fluoroethylene | 3 | 4 | 51 |
| 1-10 | | | | | carbonate | | | |
| Example | 20 | 12 | 0.3 | 800 | Fluoroethylene | 5 | 5 | 52 |
| 1-11 | | | | | carbonate | | | |
| Example | 20 | 12 | 0.3 | 800 | Fluoroethylene | 10 | 4 | 53 |
| 1-12 | | | | | carbonate | | | |
| Example | 20 | 12 | 0.3 | 800 | Fluoroethylene | 15 | 6 | 46 |
| 1-13 | | | | | carbonate | | | |
| Comparative | 20 | 12 | 0.3 | 800 | Fluoroethylene | 16 | 7 | 38 |
| example 5 | | | | | carbonate | | | |
| Example | 20 | 12 | 0.3 | 800 | Fluoroethylene | 5.3 | 6 | 46 |
| 1-14 | | | | | carbonate:vinylene | | | |
| | | | | | carbonate = 5:0.3 | | | |
| Example | 20 | 12 | 0.3 | 800 | Lithium | 0.4 | 5 | 46 |
| 1-15 | | | | | difluoro(oxalato)bo- | | | |
| | | | | | rate:lithium | | | |
| | | | | | tetrafluoroborate = 1:1 | | | |
| Example | 20 | 12 | 0.3 | 800 | Lithium | 0.4 | 4 | 49 |
| 1-16 | | | | | tetrafluoroborate:lithium | | | |
| | | | | | difluorophosphate = 1:1 | | | |
| Example | 20 | 12 | 0.3 | 800 | 1,3-dioxolane:vinylene | 0.4 | 4 | 44 |
| 1-17 | | | | | carbonate = 1:1 | | | |
| Example | 20 | 12 | 0.3 | 800 | 1,3- | 0.6 | 3 | 47 |
| 1-18 | | | | | dioxolane:difluoro- | | | |
| | | | | | pyridine:lithium | | | |
| | | | | | difluorophosphate = 1:1:1 | | | |

It should be noted that in Table 1, “/” indicates no data for this item. The electrolyte is formed by a chain ester compound, a cyclic ester compound, a first additive, and a lithium salt. A sum of mass percentages of the four components is 100%. The table only shows a mass percentage of the first additive in the electrolyte, while the mass percentages of the chain ester compound and the lithium salt remain unchanged.

According to Table 1, in Comparative example 1, no first additive is added, and therefore effective protection cannot be formed at the negative electrode interface, easily leading to lithium precipitation at the negative electrode interface, thermal runaway, and poor safety performance. In Comparative examples 2 and 3, a structural dimension of the electrode assembly does not meet requirements, resulting in a high degree of lithium precipitation and poor safety performance. In Comparative examples 4 and 5, the amount of the first additive is excessively low or excessively high, leading to poor safety performance.

In Examples 1-1 to 1-7, controlling the structural dimension parameter n*x/y of the electrode assembly to be 20 to 2000 reduces a degree of lithium precipitation compared with that in Comparative example 2, enhancing safety performance; and controlling n*x/y to be 40 to 1500 results in better safety performance.

In Examples 1-8 to 1-18, by adding different types and amounts of the first additive and controlling the amounts to be 0.1% to 15%, lithium precipitation and thermal runaway risks are reduced to varying degrees, enhancing safety performance; a mass percentage of 0.5% to 10% enhances safety performance; and a mass percentage of 1% to 5% results in the best safety performance.

Possible reasons for the above results are explained above.

### EXAMPLES 2-1 TO 2-19

Preparation of the positive electrode, negative electrode, separator, electrolyte, and lithium-ion battery was similar to Example 1-10. Differences were as follows: n, x, and y of the electrode assembly were different. Specific parameters were shown in Table 2.

The safety performance of the obtained lithium-ion batteries was tested, and the results were shown in Table 2.

TABLE 2

| | | | | | | Thermal |
|---|---|---|---|---|---|---|
| | | | | | Lithium | runaway |
| | n | x | y | | precipitation | time |
| | (layers) | (cm) | (cm) | n*x/y | level | (min) |
| Example 2-1 | 7 | 10 | 0.3 | 233 | 6 | 48 |
| Example 2-2 | 8 | 10 | 0.3 | 267 | 6 | 49 |
| Example 2-3 | 10 | 10 | 0.3 | 333 | 4 | 52 |
| Example 1-10 | 20 | 10 | 0.3 | 800 | 4 | 51 |
| Example 2-4 | 30 | 10 | 0.3 | 1000 | 3 | 55 |
| Example 2-5 | 40 | 10 | 0.3 | 1333 | 5 | 50 |
| Example 2-6 | 45 | 10 | 0.3 | 1500 | 6 | 47 |
| Example 2-7 | 20 | 1.5 | 0.3 | 100 | 6 | 45 |
| Example 2-8 | 20 | 1.8 | 0.3 | 120 | 6 | 46 |
| Example 2-9 | 20 | 3 | 0.3 | 200 | 3 | 51 |
| Example 2-10 | 20 | 5 | 0.3 | 333 | 3 | 54 |
| Example 2-11 | 20 | 12 | 0.3 | 800 | 3 | 53 |
| Example 2-12 | 20 | 20 | 0.3 | 1333 | 6 | 49 |
| Example 2-13 | 20 | 25 | 0.3 | 1667 | 6 | 45 |
| Example 2-14 | 20 | 15 | 0.2 | 1500 | 6 | 48 |
| Example 2-15 | 20 | 15 | 0.3 | 1000 | 3 | 55 |
| Example 2-16 | 20 | 15 | 0.5 | 600 | 2 | 56 |
| Example 2-17 | 20 | 15 | 0.8 | 375 | 3 | 56 |
| Example 2-18 | 20 | 15 | 1 | 300 | 3 | 51 |
| Example 2-19 | 20 | 15 | 1.2 | 250 | 5 | 46 |

According to Table 2, when n*x/y is controlled to be 20 to 2000, n, x, and y also affect the safety performance of the battery. Controlling n, x, and y to be 8≤n≤45, 1.8 cm≤x≤20 cm, and 0.22 cm≤y≤1 cm respectively results in better test results, with preferred ranges being 10≤n≤30, 3 cm≤x≤12 cm, and 0.3 cm≤y≤0.8 cm. Possible reasons are explained above.

### EXAMPLES 3-1 TO 3-15

Preparation of the positive electrode, negative electrode, separator, electrolyte, and lithium-ion battery was similar to that in Example 1-10. Differences were as follows: types and amounts b of the chain ester compound in the electrolyte are different, and amounts a of the first additive in the electrolyte were different. Specific parameters were shown in Table 3.

The safety performance of the obtained lithium-ion batteries was tested, and the results were shown in Table 3.

TABLE 3

| | | | | | | Ther- |
|---|---|---|---|---|---|---|
| | | | | | | mal |
| | | | | | Lithium | run- |
| | | | | | precip- | away |
| | a | Chain ester | b | | itation | time |
| | (%) | compound | (%) | b/a | level | (min) |
| Example 3-1 | 3 | Diethyl carbonate | 8 | 2.6 | 6 | 48 |
| Example 3-2 | 3 | Diethyl carbonate | 10 | 3.3 | 5 | 53 |
| Example 3-3 | 3 | Diethyl carbonate | 15 | 5.0 | 3 | 56 |
| Example 3-4 | 3 | Diethyl carbonate | 25 | 8.3 | 2 | 58 |
| Example 3-5 | 3 | Diethyl carbonate | 35 | 11.7 | 1 | 59 |
| Example 3-6 | 3 | Diethyl carbonate | 40 | 13.3 | 3 | 55 |
| Example 1-10 | 3 | Diethyl carbonate | 45 | 15 | 4 | 51 |
| Example 3-7 | 1.1 | Diethyl carbonate | 40 | 36.4 | 4 | 53 |
| Example 3-8 | 1.5 | Diethyl carbonate | 40 | 26.7 | 3 | 56 |
| Example 3-9 | 1.5 | Diethyl carbonate | 38 | 25.3 | 2 | 57 |
| Example 3-10 | 1.5 | Diethyl carbonate | 20 | 13.3 | 2 | 57 |
| Example 3-11 | 1.5 | Diethyl carbonate | 6 | 4 | 3 | 57 |
| Example 3-12 | 1.5 | Diethyl carbonate | 1.5 | 1 | 3 | 55 |
| Example 3-13 | 1.5 | Diethyl carbonate | 1 | 0.7 | 5 | 49 |
| Example 3-14 | 1.5 | Diethyl | 20 | 13.3 | 3 | 57 |
| | | carbonate:ethyl | | | | |
| | | methyl | | | | |
| | | carbonate = 1:1 | | | | |
| Example 3-15 | 1.5 | Diethyl | 30 | 20 | 2 | 59 |
| | | carbonate:ethyl | | | | |
| | | methyl | | | | |
| | | carbonate:ethyl | | | | |
| | | difluoroacetate = | | | | |
| | | 1:1:1 | | | | |

It should be noted that the electrolyte is formed by a chain ester compound, a cyclic ester compound, a first additive, and a lithium salt. A sum of mass percentages of the four components is 100%. The table only shows the mass percentages of the chain ester compound and the first additive, while the mass percentage of the lithium salt remains unchanged.

According to Table 3, the amount b of the chain ester compound in the electrolyte and a ratio b/a of b to the amount of the first additive affects the safety performance of the battery. When b/a is controlled to be 1 to 30, the safety performance of the battery is good; when b/a is controlled to be 4 to 25, the safety performance of the battery is better. Meanwhile, when b in the electrolyte satisfies 10% to 40%, a degree of lithium precipitation in the battery is lower, and thermal runaway is less likely, resulting in better safety performance. Possible reasons are explained above.

### EXAMPLES 4-1 TO 4-9

Preparation of the positive electrode, negative electrode, separator, electrolyte, and lithium-ion battery was similar to that in Example 3-9. Differences are as follows: the electrolyte further contains a second additive, and a type and an amount c of the second additive are different. Specific parameters were shown in Table 4.

The safety performance of the obtained lithium-ion batteries was tested, and the results were shown in Table 4.

TABLE 4

| | | | Lithium | Thermal |
|---|---|---|---|---|
| | | c | precipitation | runaway |
| | Second additive | (%) | level | time (min) |
| Example | / | / | 2 | 57 |
| 3-9 | | | | |
| Example | Succinonitrile | 0.5 | 2 | 57 |
| 4-1 | | | | |
| Example | Succinonitrile | 1 | 2 | 60 |
| 4-2 | | | | |
| Example | Succinonitrile | 3 | 2 | 62 |
| 4-3 | | | | |
| Example | Succinonitrile | 5 | 2 | 67 |
| 4-4 | | | | |
| Example | Succinonitrile | 10 | 3 | 68 |
| 4-5 | | | | |
| Example | Succinonitrile | 11 | 5 | 68 |
| 4-6 | | | | |
| Example | Adiponitrile:succinonitrile = 1:1 | 2 | 2 | 64 |
| 4-7 | | | | |
| Example | Adiponitrile: 1,3,6- | 2 | 2 | 67 |
| 4-8 | hexanetricarbonitrile = 1:1 | | | |
| Example | Adiponitrile: 1,3,6- | 3 | 2 | 68 |
| 4-9 | hexanetricarbonitrile:suberonitrile = 1:1:1 | | | |

It should be noted in Table 4, “/” indicates no data for this item. The electrolyte is formed by a chain ester compound, a cyclic ester compound, a first additive, a second additive, and a lithium salt. A sum of the mass percentages of the five components is 100%. The table only shows the mass percentage of the second additive, while the mass percentages of the chain ester compound, the first additive, and the lithium salt remain unchanged.

According to Table 4, adding an appropriate amount of the second additive can effectively further suppress lithium precipitation at the negative electrode interface, and therefore thermal runaway is less likely, improving the safety performance of the battery. A type of the second additive has little impact on the battery performance, but the amount affects the performance. Controlling the amount of the second additive to be 1% to 10% results in better safety performance of the battery. Possible reasons are explained above.

### EXAMPLES 5-1 TO 5-9

Preparation of the positive electrode, negative electrode, separator, electrolyte, and lithium-ion battery was similar to Example 4-3. Differences were as follows: the negative electrode active material in the negative electrode was graphite and a silicon-based material, and an amount M of the silicon-based material in the negative electrode active material was different. Specific parameters were shown in Table 5.

The safety performance of the obtained lithium-ion batteries is tested, and the results are shown in Table 5.

TABLE 5

| | | Lithium | Thermal |
|---|---|---|---|
| | M | precipitation | runaway |
| | (%) | level | time (min) |
| Example 4-3 | / | 2 | 57 |
| Example 5-1 | 0.3 | 2 | 53 |
| Example 5-2 | 0.5 | 2 | 56 |
| Example 5-3 | 5 | 2 | 57 |
| Example 5-4 | 20 | 2 | 59 |
| Example 5-6 | 40 | 2 | 56 |
| Example 5-7 | 60 | 2 | 58 |
| Example 5-8 | 70 | 2 | 54 |
| Example 5-9 | 75 | 2 | 50 |

Note:
In Table 5, “/” indicates no data for this item.

According to Table 5, controlling M to be 0.5% to 70% results in good safety performance of the battery while providing a high energy density. By optimizing the structural dimension of the electrode assembly in the battery and the composition of the electrolyte, stability of the electrode assembly during charge and discharge can be effectively ensured. Therefore, a silicon-based active material can be appropriately added to the negative electrode active material. Appropriately adding the silicon-based active material can also mitigate lithium precipitation at the negative electrode interface, improving the safety performance of the battery. However, the amount should not be excessively high, as an excessively high amount leads to a large volume change rate of the negative electrode during charge and discharge, affecting safety performance.

It should be noted that, without conflict, these embodiments and features in these embodiments of this application can be combined with each other.

Finally, it should be noted that the above embodiments are only used to illustrate the technical solutions of this application and are not limitations to this application. Although this application is described in detail with reference to the foregoing embodiments, persons of ordinary skill in the art should understand that modifications can still be made to the technical solutions described in the foregoing embodiments, or equivalent substitutions can be made to some technical features. However, these modifications or substitutions do not cause the essence of the corresponding technical solutions to depart from the spirit and scope of the technical solutions of these embodiments of this application.

What is claimed is:

1. A secondary battery, comprising an electrode assembly and an electrolyte; wherein the electrode assembly comprises a positive electrode, a negative electrode, and a separator; the separator is disposed between the positive electrode and the negative electrode;
the electrode assembly satisfies 20≤n*x/y≤2000, wherein
n represents a quantity of layers of the positive electrode along a thickness direction of the electrode assembly,
x represents a dimension of the longest edge of a projection of the electrode assembly along the thickness direction, and
y represents a maximum dimension of the electrode assembly along the thickness direction; and
the electrolyte comprises a first additive with a reduction potential of 0.8 V to 1.8 V, and a mass percentage of the first additive in the electrolyte is denoted as a, wherein a is 0.1% to 15%.

2. The secondary battery according to claim 1, wherein the secondary battery satisfies at least one of the following conditions:
$$40 \leq n * x / y \leq 1 \; 500 ; \qquad ( 1 )$$
$$or$$
$$a is 0.5 \% to 10 \% . \qquad ( 2 )$$

3. The secondary battery according to claim 1, wherein the secondary battery satisfies at least one of the following conditions:
$$300 \leq n * x / y \leq 1 \; 500 ; \qquad ( 3 )$$
$$or$$
$$a is 1 \% to 5 \% . \qquad ( 4 )$$

4. The secondary battery according to claim 1, wherein the first additive comprises at least one of fluoroethylene carbonate, vinylene carbonate, lithium difluoro(oxalato)borate, difluoropyridine, lithium tetrafluoroborate, lithium difluorophosphate, 1,3-dioxane, 1,4-dioxane, or 1,3-dioxolane.

5. The secondary battery according to claim 1, wherein the secondary battery satisfies at least one of the following conditions:
$$8 \leq n \leq 45 ; \qquad ( 5 )$$
$$1.8 cm \leq x \leq 20 cm ; \qquad ( 6 )$$
$$or$$
$$0.22 cm \leq y \underline{<} 1 cm . \qquad ( 7 )$$

6. The secondary battery according to claim 1, wherein the secondary battery satisfies at least one of the following conditions:
$$10 \leq n \leq 30 ; \qquad ( 8 )$$
$$3 cm \leq x \leq 12 cm ; \qquad ( 9 )$$
$$or$$
$$0.3 cm \leq y \underline{<} 0.8 cm . \qquad ( 10 )$$

7. The secondary battery according to claim 1, wherein the electrolyte comprises a chain ester compound, a mass percentage of the chain ester compound in the electrolyte is b, and a ratio b/a of b to a is 1 to 30.

8. The secondary battery according to claim 1, wherein the electrolyte comprises a chain ester compound, a mass percentage of the chain ester compound in the electrolyte is b, and a ratio b/a of b to a is 4 to 25.

9. The secondary battery according to claim 7, wherein the chain ester compound comprises at least one of dimethyl carbonate, diethyl carbonate, ethyl methyl carbonate, methyl acetate, ethyl propionate, propyl propionate, methyl propionate, ethyl fluoroacetate, methyl difluoroacetate, ethyl difluoroacetate, ethyl trifluoroacetate, methyl trifluoroacetate, tert-butyl trifluoroacetate, ethyl 2,2,2-trifluoroacetate, ethyl 2-fluoroisobutyrate, butyl trifluoroacetate, methyl 2-fluoroisobutyrate, methyl 2,2-difluoropropionate, vinyl trifluoroacetate, ethyl 2-fluoropropionate, n-butyl difluoroacetate, bis(2,2,2-trifluoroethyl) carbonate, 2,2,2-trifluoroethyl carbonate, methyl trifluoroethyl carbonate, or ethyl trifluoroethyl carbonate.

10. The secondary battery according to claim 8, wherein the chain ester compound comprises at least one of dimethyl carbonate, diethyl carbonate, ethyl methyl carbonate, methyl acetate, ethyl propionate, propyl propionate, methyl propionate, ethyl fluoroacetate, methyl difluoroacetate, ethyl difluoroacetate, ethyl trifluoroacetate, methyl trifluoroacetate, tert-butyl trifluoroacetate, ethyl 2,2,2-trifluoroacetate, ethyl 2-fluoroisobutyrate, butyl trifluoroacetate, methyl 2-fluoroisobutyrate, methyl 2,2-difluoropropionate, vinyl trifluoroacetate, ethyl 2-fluoropropionate, n-butyl difluoroacetate, bis(2,2,2-trifluoroethyl) carbonate, 2,2,2-trifluoroethyl carbonate, methyl trifluoroethyl carbonate, or ethyl trifluoroethyl carbonate.

11. The secondary battery according to claim 7, wherein b is 10% to 40%.

12. The secondary battery according to claim 8, wherein b is 10% to 40%.

13. The secondary battery according to claim 1, wherein the electrolyte further comprises a second additive, and a mass percentage of the second additive in the electrolyte is denoted as c, wherein c is 1% to 10%; and
the second additive is at least one selected from succinonitrile, glutaronitrile, adiponitrile, pimelonitrile, suberonitrile, azelanitrile, triphenyl phosphate, triethyl trimethylsilyl phosphate, or 1,3,6-hexanetricarbonitrile.

14. The secondary battery according to claim 1, wherein the negative electrode comprises a negative electrode active material layer, the negative electrode active material layer comprises a negative electrode active material, and the negative electrode active material comprises a silicon-based active material.

15. The secondary battery according to claim 14, wherein a mass percentage of the silicon-based active material in the negative electrode active material is M, wherein M is 0.5% to 70%.

16. An electronic device, comprising a secondary battery, the secondary battery comprises an electrode assembly and an electrolyte; wherein the electrode assembly comprises a positive electrode, a negative electrode, and a separator, and the separator is disposed between the positive electrode and the negative electrode;
the electrode assembly satisfies 20≤n*x/y≤2000, wherein
n represents a quantity of layers of the positive electrode along a thickness direction of the electrode assembly,
x represents a dimension of the longest edge of a projection of the electrode assembly along the thickness direction, and
y represents a maximum dimension of the electrode assembly along the thickness direction; and
the electrolyte comprises a first additive with a reduction potential of 0.8 V to 1.8 V, and a mass percentage of the first additive in the electrolyte is denoted as a, wherein a is 0.1% to 15%.

17. The electronic device according to claim 16, wherein the secondary battery satisfies at least one of the following conditions:
$$40 \leq n * x / y \leq 1 \; 500 ; \qquad ( 1 )$$
$$or$$
$$a is 0.5 \% to 10 \% . \qquad ( 2 )$$

18. The electronic device according to claim 16, wherein the secondary battery satisfies at least one of the following conditions:
$$300 \leq n * x / y \leq 1 \; 500 ; \qquad ( 3 )$$
$$or$$
$$a is 1 \% to 5 \% . \qquad ( 4 )$$

19. The electronic device according to claim 16, wherein the first additive comprises at least one of fluoroethylene carbonate, vinylene carbonate, lithium difluoro(oxalato)borate, difluoropyridine, lithium tetrafluoroborate, lithium difluorophosphate, 1,3-dioxane, 1,4-dioxane, or 1,3-dioxolane.

20. The electronic device according to claim 16, wherein the secondary battery satisfies at least one of the following conditions:
$$8 \leq n \leq 45 ; \qquad ( 5 )$$
$$1.8 cm \leq x \leq 20 cm ; \qquad ( 6 )$$
$$or$$
$$0.22 cm \leq y \underline{<} 1 cm . \qquad ( 7 )$$
